(19) United States
(12) Patent Application Publication
(10) Pub. No.: US 2014/0133032 A1
(43) Pub. Date: May 15, 2014

(54) OPTICAL ELEMENT HAVING ANTIREFLECTIVE FILM, OPTICAL SYSTEM, AND OPTICAL APPARATUS

(71) Applicant: CANON KABUSHIKI KAISHA, Tokyo (JP)

(72) Inventors: Sayoko Amano, Utsunomiya-shi (JP); Kazuhiko Momoki, Koshigaya-shi (JP); Kazue Uchida, Utsunomiya-shi (JP)

(73) Assignee: CANON KABUSHIKI KAISHA, Tokyo (JP)

(21) Appl. No.: 14/071,798

(22) Filed: Nov. 5, 2013

(30) Foreign Application Priority Data
Nov. 12, 2012 (JP) 2012-248743

(51) Int. Cl. G02B 1/11

(52) U.S. Cl. CPC G02B 1/115; B82Y 20/00
USPC 359/601; 977/773

(57) ABSTRACT

An optical element includes a substrate that is transparent, and an antireflective film laminated on the substrate. The antireflective film includes, in order from the substrate, a first layer, a second layer, and a third layer. The substrate has a refractive index of 1.80 to 2.05 for the d-line. The first layer is an inorganic oxide film having a refractive index of 1.43 to 1.47 for the d-line and a physical film thickness of 29.0 to 40.0 nm and containing silica as a main component. The second layer is an inorganic oxide film having a refractive index of 2.00 to 2.20 for the d-line and a physical film thickness of 12.0 to 41.0 nm. The third layer is a film having a refractive index of 1.23 to 1.26 for the d-line and a physical film thickness of 110.0 to 130.0 nm and containing silica nanoparticles.

### BACKGROUND OF THE INVENTION

1. Field of the Invention

The present invention relates to an optical element having an antireflective film, an optical system, and an optical apparatus.

2. Description of the Related Art

In general, in order to form a high-performance antireflective film on a substrate having a high refractive index, the outermost layer of the antireflective film needs to have a low refractive index. It is known that an inorganic material such as silicone resin or a magnesium fluoride or an organic material such as a silicone resin or an amorphous fluorine resin is used as a material of the layer having a low refractive index. It is also known that vacant spaces configured to further suppress the reflectance are formed in a silicone resin layer or in a magnesium fluoride layer. For example, a thin-film magnesium fluoride layer having a refractive index of 1.38 has a porocity of 30% (volume), so that the refractive index can be reduced down to 1.27. It is known that a sol-gel method is used as a method of forming vacant spaces to deposit magnesium fluoride nanoparticles and an antireflective film is formed by using a low refractive index material where the vacant spaces are formed between the nanoparticles (Japanese Patent Laid-Open No. (“JP”) 2010-15186). Another known method of forming vacant spaces includes aging a mixture of a solvent, an acidic catalyst, and a surfactant, hydrolyzing and poly-condensing alkoxy silane, coating the resultant material with a sol solution added with a basic catalyst, followed by drying, removing the solvent, and calcining (JP 2010-55060).

However, the antireflective films disclosed in JP 2010-15186 and JP 2010-55060 are applied to a substrate having a refractive index from 1.52 to 1.60, and the documents do not disclose or suggest an antireflective film which is appropriate for a high refractive index substrate having a refractive index of 1.80 or more.

### SUMMARY OF THE INVENTION

The present invention provides an optical element, an optical system, and an optical apparatus having an excellent low reflectance characteristic and having a high antireflection performance for a high reflective index glass.

An optical element according to the present invention includes a substrate that is transparent to light in a wavelength range to be used, and an antireflective film laminated on the substrate. The antireflective film includes, in order from the substrate, a first layer, a second layer, and a third layer. The substrate has a refractive index of 1.80 to 2.05 for a d-line. The first layer is an inorganic oxide film having a refractive index of 1.43 to 1.47 for the d-line and a physical film thickness of 29.0 to 40.0 nm and containing silica as a main component. The second layer is an inorganic oxide film having a refractive index of 2.00 to 2.20 for the d-line and a physical film thickness of 12.0 to 41.0 nm. The third layer is a film having a refractive index of 1.23 to 1.26 for the d-line and a physical film thickness of 110.0 to 130.0 nm and containing silica nanoparticles.

Further features of the present invention will become apparent from the following description of exemplary embodiments with reference to the attached drawings.

### BRIEF DESCRIPTION OF THE DRAWINGS

FIG. 1 is a schematic sectional view illustrating an optical element according to first to eight embodiments of the present embodiment.

FIG. 2 illustrates a reflectance characteristic of an optical element according to the first embodiment of the present invention.

FIG. 3 illustrates a reflectance characteristic of an optical element according to the second embodiment of the present invention.

FIG. 4 illustrates a reflectance characteristic of an optical element according to the third embodiment of the present invention.

FIG. 5 illustrates a reflectance characteristic of an optical element according to the fourth embodiment of the present invention.

FIG. 6 illustrates a reflectance characteristic of an optical element according to the fifth embodiment of the present invention.

FIG. 7 illustrates a reflectance characteristic of an optical element according to the sixth embodiment of the present invention.

FIG. 8 illustrates a reflectance characteristic of an optical element according to the the seventh embodiment of the present invention.

FIG. 9 illustrates a reflectance characteristic of an optical element according to the eighth embodiment of the present invention.

FIG. 10 illustrates reflectance characteristics of optical elements according to a comparative example 1 and the first embodiment.

FIG. 11 illustrates reflectance characteristics of optical elements according to a comparative example 2 and the second embodiment.

### DESCRIPTION OF THE EMBODIMENTS

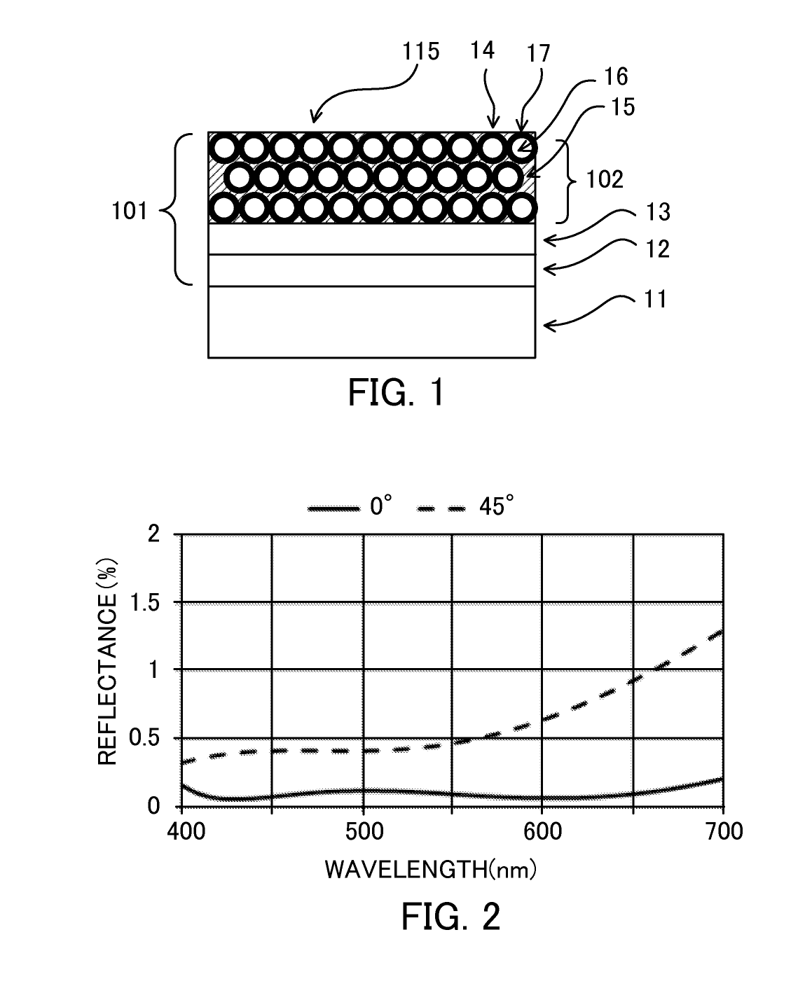

FIG. 1 is a schematic sectional view of an optical element according to this embodiment. The optical element includes a substrate 11 which is transparent to light in a wavelength range to be used (visible range) in use and an antireflective film 101 formed on the substrate 11. The antireflective film 101 has a three-layered structure in which a first layer 12, a second layer 13, and a third layer 102 are laminated on the substrate 11 in this order in the direction outward from the substrate 11.

The substrate 11 is a glass substrate having a refractive index of 1.80 to 2.05 for the d-line (wavelength 587.6 nm). The shape of the substrate 11 is not particularly limited, and the shape may be planar, curved, concave, convex, or film-shaped. The substrate 11 having a high refractive index is appropriate for a high-accuracy digital camera. Note that the substrate 11 is not particularly limited to a glass, and the substrate 11 may be configured by using other materials such as a resin.

The first layer 12 is an inorganic oxide film having a refractive index of 1.43 to 1.47 for the d-line and a physical film thickness of 29.0 to 40.0 nm and containing silica as a main component and is made of, for example, SiO₂. Thereby, an adhesive force between the first layer 12 and the silica as a main component of the glass substrate 11 increases and an adhesion strength of the film increases.

The second layer 13 is an inorganic oxide film having a refractive index of 2.00 to 2.20 for the d-line and a physical film thickness of 12.0 to 41.0 nm. The physical film thickness may range from 12.0 to 30.0 nm. The second layer 13 is an adjustment film for the first layer 12 and the third layer 102 in order to obtain a low reflectance characteristic of the antireflective film, and the above ranges of the refractive index and the physical film thickness may be provided. The second layer 13 may be made of a zirconium oxide, a titanium oxide, a tantalum oxide, a niobic oxide, a hafnium oxide, a lanthanum oxide, alumina, silica, or a mixture of at least two of these materials.

The first layer 12 and the second layer 13 are inorganic films made of an oxide. A dielectric antireflective film constructed with an inorganic film may be formed through a vacuum evaporation method. The formation method of the dielectric antireflective film is not particularly limited thereto, but a sputtering method may be used.

The third layer 102 is closest to air 115. The third layer 102 is a film having a refractive index of 1.23 to 1.26 for the d-line and a physical film thickness of 110.0 to 130.0 nm and containing silica nanoparticles. In FIG. 1, the silica nanoparticles of the third layer 102 are configured by binding hollow nanoparticles 14 with binder 15 to increase the strength of the film. However, the silica of the third layer 102 may be mesoporous silica. Each of the hollow nanoparticles 14 has an inner cavity 16 and a shell 17 outside the cavity 16. The hollow nanoparticles 14 can decrease the refractive index by using the air (refractive index of 1.0) contained in the cavity 16. Since there are not adsorptions of moisture or impurities inside the cavity 16, the environmental resistance becomes good and the refractive index becomes stable.

The cavity 16 may be a single cavity or multiple cavities and this structure may be properly selected. The shell 17 may be made of a material having a low refractive index. An inorganic material such as SiO₂, MgF₂ or an organic material such as fluorine, silicone may be used as the material of the shell 17. Since the particles of SiO₂ can be easily manufactured, SiO₂ may be used. The average particle diameter of the hollow nanoparticle 14 may be 20 nm or more and 70 nm or less, or 30 nm or more and 60 nm or less. If the average particle diameter of the hollow nanoparticle 14 is less than 20 nm, the size of the cavity 16 decreases and it is difficult to decrease the refractive index. If the average particle diameter is nm or more, the vacant space size among the particles increases and scattering occurs due to the size of the particles.

The binder of this embodiment may be made of an organic material or an inorganic material depending upon optical characteristics of films, the abrasion resistance, the adhesion force, and the environmental reliability. However, in terms of the refractive index and the abrasion resistance, it may be made of a silane alkoxy hydrolysis condensate or a partial-hydrolysis condensate. Assume that a coating material of a mixture of the hollow nanoparticles 14 and the silane alkoxy hydrolysis condensate as the binder 15 is used for the third layer 102. Then, as the weight ratio of solid contents of the hollow silica nanoparticles and the silane alkoxy hydrolysis condensate contained in the coating material, (weight of solid content of hollow silica nanoparticle): (weight of solid content of binder) may be in a range of 7:3 to 8:2. This range provides the layer with a low refractive index and a strong film strength and maintains the abrasion resistance.

The formation method of the third layer is not particularly limited, and it is possible to use a general coating method for a liquid coating solution such as a dip coating, a spin coating, a spray coating, or a roll coating. The drying after the coating may be performed by using such as a drier, a hot plate, or an electric furnace. The temperature and time in the dry condition are set to a degree that the drying can be performed to evaporate an organic solution in the hollow particles without influencing on the substrate 11. In general, the temperature of 300° C. or less may be used. The number of coating processes is not particularly limited.

The optical element according to the present embodiment is appropriate for an imaging optical system of an imaging apparatus (optical apparatus) such as a digital still camera, a digital video camera, or a television camera. The antireflective film 101 is installed on two surfaces or one surface of the optical element to effectively increase an amount of transmitting light and to effectively avoid ghost and flare caused by unnecessary light. Of course, the optical apparatus is not particularly limited to imaging apparatuses such as binoculars, telescopes, or microscopes.

### First Embodiment

An optical element according to a first embodiment has the configuration illustrated in FIG. 1. The substrate 11 may be made of a transparent glass substrate having a refractive index of 1.806 for the d-line. After the glass substrate is rinsed, the first layer 12 is formed by using SiO₂ having a refractive index of 1.46 for the d-line to have a physical film thickness of only 38.2 nm through a vacuum evaporation method. Next, the second layer 13 is formed by using Ta₂O₅ having a refractive index of 2.11 for the d-line to have a physical film thickness of only 14 nm through a vacuum evaporation method. Next, the third layer 102 is formed by coating an adjusted mixture solution of a solution containing hollow SiO₂ particles and a binder solution by using a spin coater to have a physical film thickness of 117.3 nm. The refractive index of the d-line is 1.25. The condition of rotation speed of the spin coater is preset. After the coating, the product is calcined in a clean oven in a temperature range of 100° C. to 250° C. for one hour. Table 1 describes the d-line refractive index and thickness of the optical element according to the first embodiment.

TABLE 1

| | refractive index | physical film |
|---|---|---|
| | (λ = 587.6 nm) | thickness (nm) |
| substrate | 1.806 | |
| first layer | 1.46 | 38.2 |
| second layer | 2.11 | 14.0 |
| third layer | 1.25 | 117.3 |

FIG. 2 illustrates a characteristic of the optical element according to the first embodiment measured by a spectroreflectometer, in which the abscissa axis denotes a wavelength (nm), and the ordinate axis denotes reflectance (%). As illustrated in FIG. 2, the optical element according to the first embodiment has a good characteristic of reflectance of 0.3% or less over the entire visible range of wavelength of 400 nm to 700 nm at the incident angle of 0°. The optical element according to the first embodiment has a low reflectance characteristic of reflectance of 1% or less in a wavelength range of 400 to 650 nm and 1.5% or less at the wavelength of 700 nm at the incident angle of 45°. A load of 300 g/cm² is reciprocatively exerted 20 times with a non-woven cotton fabric Clint (trade name, a product of Unitika Ltd.). No scratches are observed on the surface of the antireflective film 101.

### Second Embodiment

An optical element of a second embodiment also has the configuration illustrated in FIG. 1. The substrate 11 is made of a transparent glass substrate having a refractive index of 2.003 for the d-line. After the glass substrate is rinsed, the first layer 12 is formed by using SiO₂ having a refractive index of 1.46 for the d-line to have a physical film thickness of only 29.0 nm through the vacuum evaporation method. Next, the second layer 13 is formed by using an evaporation material having a refractive index of 2.00 for the d-line to have a physical film thickness of only 23.7 nm through the vacuum evaporation method. Next, the third layer 102 is formed by coating an adjusted mixture solution of a solution containing hollow SiO₂ particles and a binder solution by using a spin coater to have a physical film thickness of 114.8 nm. The refractive index of the d-line is 1.25. The condition of rotation speed of the spin coater is preset. After the coating, the product is calcined in a clean oven in a temperature range of 100° C. to 250° C. for one hour. Table 2 describes the d-line refractive index and thickness of the optical element according to the second embodiment.

TABLE 2

| | refractive index | physical film |
|---|---|---|
| | (λ = 587.6 nm) | thickness (nm) |
| substrate | 2.003 | |
| first layer | 1.46 | 29.0 |
| second layer | 2.00 | 23.7 |
| third layer | 1.25 | 114.8 |

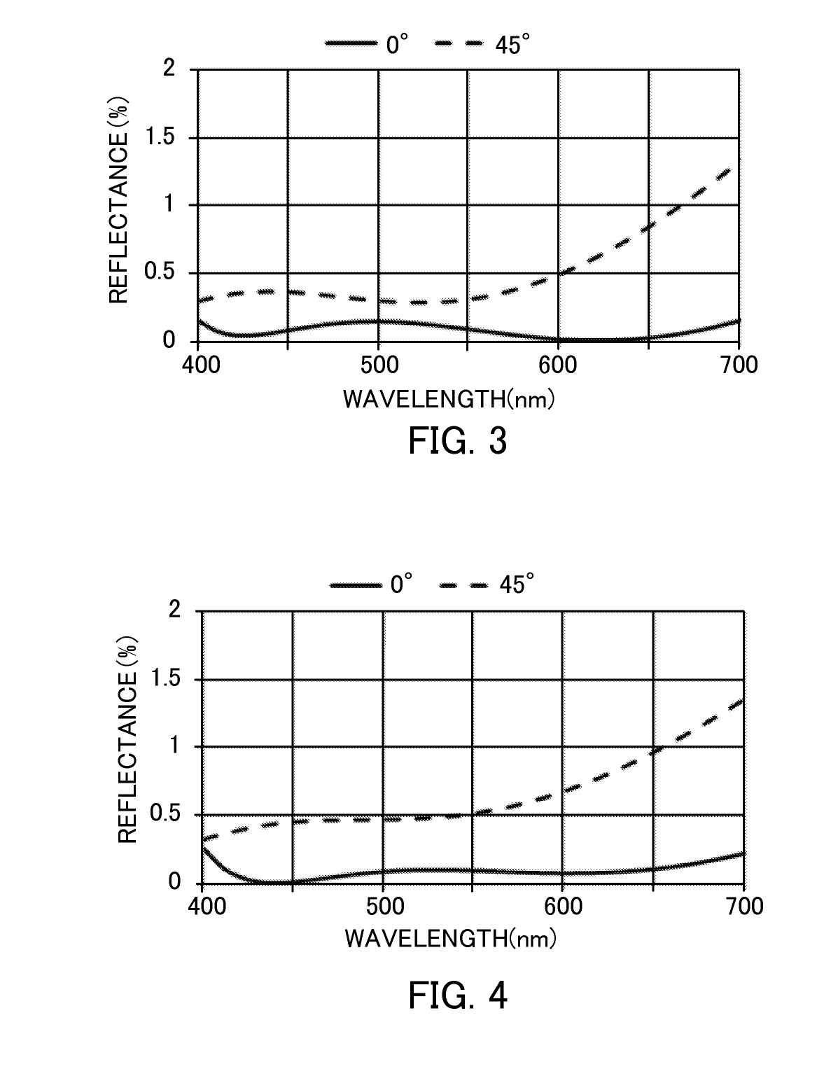

FIG. 3 illustrates a characteristic of the optical element according to the second embodiment measured by the spectroreflectometer, in which the abscissa axis denotes a wavelength (nm), and the ordinate axis denotes reflectance (%). As illustrated in FIG. 3, the optical element according to the second embodiment has a good characteristic of reflectance of 0.3% or less over the entire visible range of wavelength of 400 nm to 700 nm at the incident angle of 0°. The optical element according to the second embodiment has a low reflectance characteristic of reflectance of 1% or less in a wavelength range of 400 to 650 nm and 1.5% or less at the wavelength of 700 nm at the incident angle of 45°. Similarly to the first embodiment, in the observation of surface film strength, no scratches are observed.

### Third Embodiment

An optical element according to a third embodiment also has the configuration illustrated in FIG. 1. The substrate 11 is made of a transparent glass substrate having a refractive index of 1.883 for the d-line. After the glass substrate is rinsed, the first layer 12 is formed by using SiO₂ having a refractive index of 1.46 for the d-line to have a physical film thickness of only 37.3 nm through the vacuum evaporation method. Next, the second layer 13 is formed by using an evaporation material having a refractive index of 2.20 for the d-line to have a physical film thickness of only 14.8 nm through a vacuum evaporation method. Next, the third layer 102 is formed by coating an adjusted mixture solution of a solution containing hollow SiO₂ particles and a binder solution by using a spin coater to have a physical film thickness of 117.5 nm. The refractive index of the d-line is 1.25. The condition of rotation speed of the spin coater is preset. After the coating, the product is calcined in a clean oven in a temperature range of 100° C. to 250° C. for one hour. Table 3 describes the d-line refractive index and thickness of the optical element according to the third embodiment.

TABLE 3

| | refractive index | physical film |
|---|---|---|
| | (λ = 587.6 nm) | thickness (nm) |
| substrate | 1.883 | |
| first layer | 1.46 | 37.3 |
| second layer | 2.20 | 14.8 |
| third layer | 1.25 | 117.5 |

FIG. 4 illustrates a characteristic of the optical element according to the third embodiment measured by the spectroreflectometer, in which the abscissa axis denotes a wavelength (nm), and the ordinate axis denotes reflectance (%). As illustrated in FIG. 4, the optical element according to the third embodiment has a good characteristic of reflectance of 0.3% or less over the entire visible range of wavelength of 400 nm to 700 nm at the incident angle of 0°. The optical element according to the third embodiment also has a low reflectance characteristic of reflectance of 1% or less in a wavelength range of 400 to 650 nm and 1.5% or less at the wavelength of 700 nm at the incident angle of 45°. Similarly to the first embodiment, in the observation of surface film strength, no scratches are observed.

### Fourth Embodiment

An optical element according to a fourth embodiment also has the configuration illustrated in FIG. 1. The substrate 11 is made of a transparent glass substrate having a refractive index of 1.800 for the d-line. After the glass substrate is rinsed, the first layer 12 is formed by using SiO₂ having a refractive index of 1.43 for the d-line to have a physical film thickness of only 40.0 nm through a vacuum evaporation method. Next, the second layer 13 is formed by using an evaporation material having a refractive index of 2.20 for the d-line to have a physical film thickness of only 12.0 nm through the vacuum evaporation method. Next, the third layer 102 is formed by coating an adjusted mixture solution of a solution containing hollow SiO₂ particles and a binder solution by using a spin coater to have a physical film thickness of 130.0 nm. The refractive index of the d-line is 1.23. The condition of rotation speed of the spin coater is preset. After the coating, the product is calcined in a clean oven in a temperature range of 100° C. to 250° C. for one hour. Table 4 describes the d-line refractive index and thickness of the optical element according to the fourth embodiment.

TABLE 4

| | refractive index | physical film |
|---|---|---|
| | (λ = 587.6 nm) | thickness (nm) |
| substrate | 1.800 | |
| first layer | 1.43 | 40.0 |
| second layer | 2.20 | 12.0 |
| third layer | 1.23 | 130.0 |

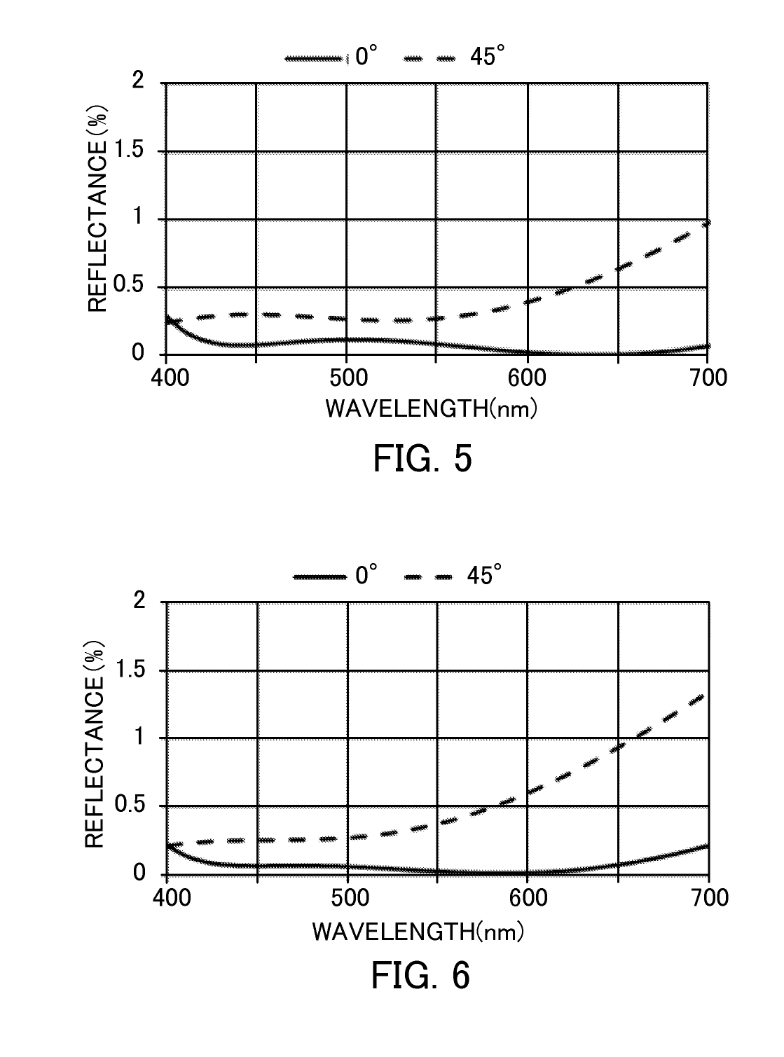

FIG. 5 illustrates a characteristic of the optical element according to the fourth embodiment measured by the spectroreflectometer, in which the abscissa axis denotes a wavelength (nm), and the ordinate axis denotes reflectance (%). As illustrated in FIG. 5, the optical element according to the fourth embodiment has a good characteristic of reflectance of 0.3% or less over the entire visible range of wavelength of 400 nm to 700 nm at the incident angle of 0°. The optical element according to the fourth embodiment also has a low reflectance characteristic of reflectance of 0.5% or less in a wavelength range of 400 to 650 nm and 1.1% or less at the wavelength of 700 nm at the incident angle of 45°. Similarly to the first embodiment, in the observation of surface film strength, no scratches are observed.

### Fifth Embodiment

An optical element according to a fifth embodiment 5 also has the configuration illustrated in FIG. 1. The substrate 11 is made of a transparent glass substrate having a refractive index of 1,800 for the d-line. After the glass substrate is rinsed, the first layer 12 is formed using SiO₂ having a refractive index of 1.43 for the d-line to have a physical film thickness of only 34.2 nm through the vacuum evaporation method. Next, the second layer 13 is formed using an evaporation material having a refractive index of 2.00 for the d-line to have a physical film thickness of only 17.4 nm through the vacuum evaporation method. Next, the third layer 102 is formed by coating an adjusted mixture solution of a solution containing hollow SiO₂ particles and a binder solution by using a spin coater to have a physical film thickness of 118.1 nm. The refractive index of the d-line is 1.23. The condition of rotation speed of the spin coater is preset. After the coating, the product is calcined in a clean oven in a temperature range of 100° C. to 250° C. for one hour. Table 5 describes the d-line refractive index and thickness of the optical element according to the fifth embodiment.

TABLE 5

| | refractive index | physical film |
|---|---|---|
| | (λ = 587.6 nm) | thickness (nm) |
| substrate | 1.800 | |
| first layer | 1.43 | 34.2 |
| second layer | 2.00 | 17.4 |
| third layer | 1.23 | 118.1 |

FIG. 6 illustrates a characteristic of the optical element according to the fifth embodiment measured by the spectroreflectometer, in which the abscissa axis denotes a wavelength (nm), and the ordinate axis denotes reflectance (%). As illustrated in FIG. 6, the optical element according to the fifth embodiment has a good characteristic of reflectance of 0.3% or less over the entire visible range of wavelength of 400 nm to 700 nm at the incident angle of 0°. The optical element according to the fifth embodiment has a low reflectance characteristic of reflectance of 1.0% or less in a wavelength range of 400 to 650 nm and 1.5% or less at the wavelength of 700 nm at the incident angle of 45°. Similarly to the first embodiment, in the observation of surface film strength, no scratches are observed.

### Sixth Embodiment

An optical element according to a sixth embodiment 6 also has the configuration illustrated in FIG. 1. The substrate 11 is made of a transparent glass substrate having a refractive index of 1.800 for the d-line. After the glass substrate is rinsed, the first layer 12 is formed using SiO₂ having a refractive index of 1.43 for the d-line to have a physical film thickness of only 40.0 nm through the vacuum evaporation method. Next, the second layer 13 is formed using an evaporation material having a refractive index of 2.20 for the d-line to have a physical film thickness of only 12.3 nm through a vacuum evaporation method. Next, the third layer 102 is formed by coating an adjusted mixture solution of a solution containing hollow SiO₂ particles and a binder solution by using a spin coater to have a physical film thickness of 118.7 nm. The refractive index of the d-line is 1.26. The condition of rotation speed of the spin coater is preset. After the coating, the product is calcined in a clean oven in a temperature range of 100° C. to 250° C. for one hour. Table 6 describes the d-line refractive index and thickness of the optical element according to the sixth embodiment.

TABLE 6

| | refractive index | physical film |
|---|---|---|
| | (λ = 587.6 nm) | thickness (nm) |
| substrate | 1.800 | |
| first layer | 1.43 | 40.0 |
| second layer | 2.20 | 12.3 |
| third layer | 1.26 | 118.7 |

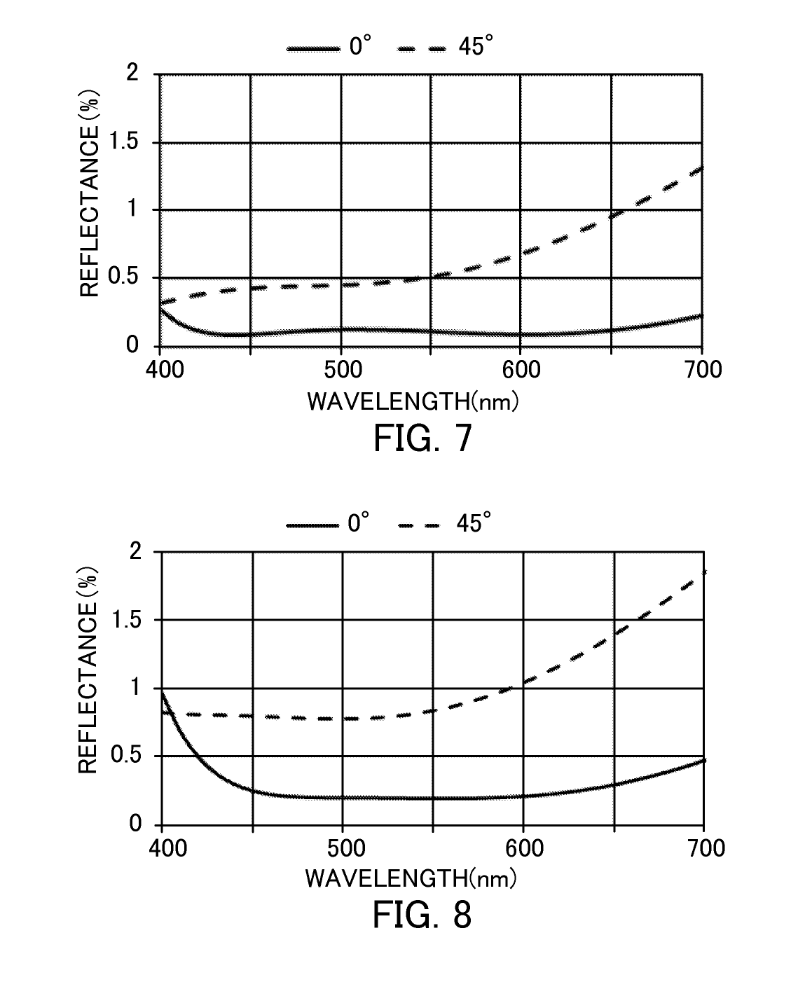

FIG. 7 illustrates a characteristic of the optical element according to a sixth embodiment measured by the spectroreflectometer, in which the abscissa axis denotes a wavelength (nm), and the ordinate axis denotes reflectance (%). As illustrated in FIG. 7, the optical element according to the sixth embodiment has a good characteristic of reflectance of 0.3% or less over the entire visible range of wavelength of 400 nm to 700 nm at the incident angle of 0°. The optical element according to the sixth embodiment also has a low reflectance characteristic of reflectance of 1.0% or less in a wavelength range of 400 to 650 nm and 1.5% or less at the wavelength of 700 nm at the incident angle of 45°. Similarly to the first embodiment, in the observation of surface film strength, no scratches are observed.

### Seventh Embodiment

An optical element according to a seventh embodiment also has the configuration illustrated in FIG. 1. The substrate 11 is made of a transparent glass substrate having a refractive index of 2.003 for the d-line. After the glass substrate is rinsed, the first layer 12 is formed using SiO₂ having a refractive index of 1.43 for the d-line to have a physical film thickness of only 29.0 nm through the vacuum evaporation method. Next, the second layer 13 is formed by using an evaporation material having a refractive index of 2.00 for the d-line to have a physical film thickness of only 29.0 nm through a vacuum evaporation method. Next, the third layer 102 is formed by coating an adjusted mixture solution of a solution containing hollow SiO₂ particles and a binder solution by using a spin coater to have a physical film thickness of 110.0 nm. The refractive index of the d-line is 1.23. The condition of rotation speed of the spin coater is preset. After the coating, the product is calcined in a clean oven in a temperature range of 100° C. to 250° C. for one hour. Table 7 describes the d-line refractive index and thickness of the optical element according to the seventh embodiment.

TABLE 7

| | refractive index | physical film |
|---|---|---|
| | (λ = 587.6 nm) | thickness (nm) |
| substrate | 2.003 | |
| first layer | 1.43 | 29.0 |
| second layer | 2.00 | 29.0 |
| third layer | 1.23 | 110.0 |

FIG. 8 illustrates a characteristic of the optical element according to the seventh embodiment measured by the spectroreflectometer, in which the abscissa axis denotes a wavelength (nm), and the ordinate axis denotes reflectance (%). As illustrated in FIG. 8, the optical element according to the seventh embodiment has a good characteristic of reflectance of 0.5% or less over the entire visible range of wavelength of 420 nm to 700 nm at the incident angle of 0°. The optical element according to the seventh embodiment also has a low reflectance characteristic of reflectance of 1.5% or less in a wavelength range of 400 to 650 nm and 1.8% or less at the wavelength of 700 nm at the incident angle of 45°. Similarly to the first embodiment 1, in the observation of surface film strength, no scratches are observed.

### Eighth Embodiment

An optical element according to an eighth embodiment also has the configuration illustrated in FIG. 1. The substrate 11 is made of a transparent glass substrate having a refractive index of 2.003 for the d-line. After the glass substrate is rinsed, the first layer 12 is formed using SiO₂ having a refractive index of 1.47 for the d-line to have a physical film thickness of only 30.8 nm through the vacuum evaporation method. Next, the second layer 13 is formed using an evaporation material having a refractive index of 2.20 for the d-line to have a physical film thickness of only 17.5 nm through a vacuum evaporation method. Next, the third layer 102 is formed by coating an adjusted mixture solution of a solution containing hollow SiO₂ particles and a binder solution by using a spin coater to have a physical film thickness of 116.5 nm. The refractive index of the d-line is 1.26. The condition of rotation speed of the spin coater is preset. After the coating, the product is calcined in a clean oven in a temperature range of 100° C. to 250° C. for one hour. The d-line refractive index and thickness of the optical element according to the eighth embodiment are listed in Table 8.

TABLE 8

| | refractive index | physical film |
|---|---|---|
| | (λ = 587.6 nm) | thickness (nm) |
| substrate | 2.003 | |
| first layer | 1.47 | 30.8 |
| second layer | 2.20 | 17.5 |
| third layer | 1.26 | 116.5 |

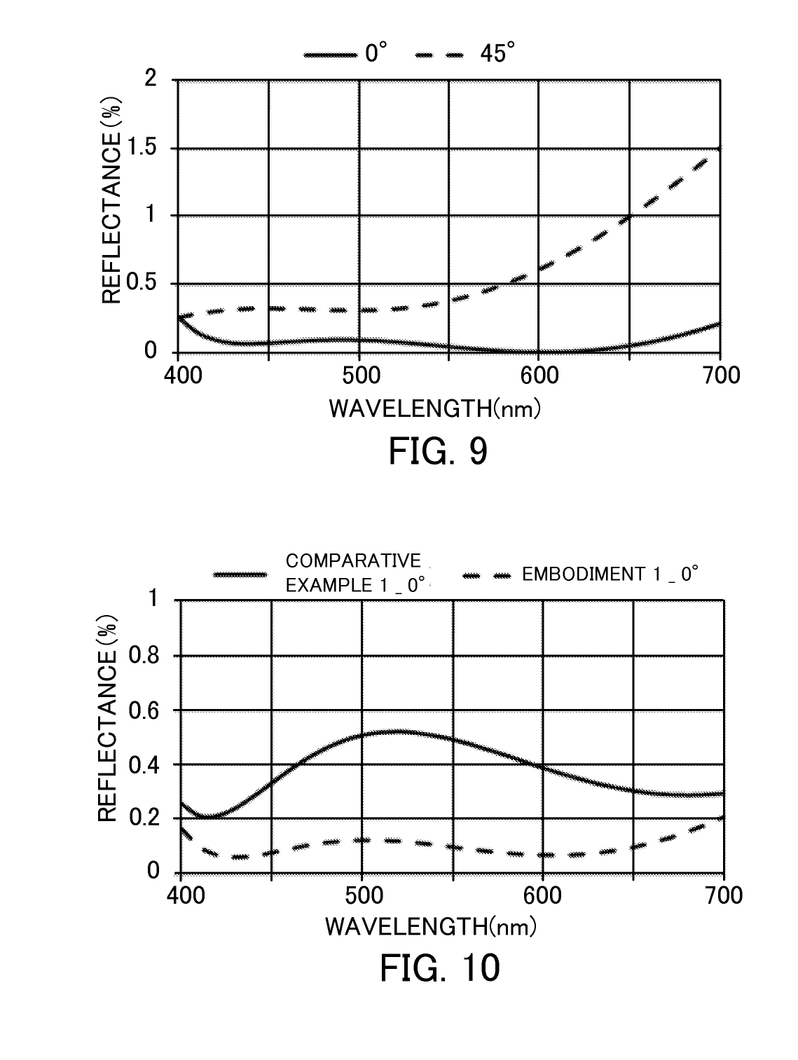

FIG. 9 illustrates a characteristic of the optical element according to the eighth embodiment measured by the spectroreflectometer, in which the abscissa axis denotes a wavelength (nm), and the ordinate axis denotes reflectance (%). As illustrated in FIG. 9, the optical element according to the eighth embodiment has a good characteristic of reflectance of 0.3% or less over the entire visible range of wavelength of 400 nm to 700 nm at the incident angle of 0°. The optical element according to the eighth embodiment also has a low reflectance characteristic of reflectance of 1.0% or less in a wavelength range of 400 to 650 nm and 1.6% or less at the wavelength of 700 nm at the incident angle of 45°. Similarly to the first embodiment, in the observation of surface film strength, no scratches are observed.

### COMPARATIVE EXAMPLE 1

An optical element according to a comparative example 1 also has the configuration illustrated in FIG. 1. The substrate 11 is made of a transparent glass substrate having a refractive index of 1.806 for the d-line. After the glass substrate is rinsed, the first layer 12 is formed using SiO₂ having a refractive index of 1.46 for the d-line to have a physical film thickness of only 38.2 nm through the vacuum evaporation method. Next, the second layer 13 is formed by using Ta₂O₅ having a refractive index of 2.11 for the d-line to have a physical film thickness of only 14 nm through a vacuum evaporation method. Next, the third layer 102 is formed by coating an adjusted mixture solution of a solution containing hollow SiO₂ particles and a binder solution by using a spin coater to have a physical film thickness of 117.3 nm. The refractive index of the d-line is 1.30. The condition of rotation speed of the spin coater is preset. After the coating, the product was calcined in a clean oven in a temperature range of 100° C. to 250° C. for one hour. The d-line refractive index and thickness of the optical element according to the comparative example 1 are listed in Table 9.

TABLE 9

| | refractive index | physical film |
|---|---|---|
| | (λ = 587.6 nm) | thickness (nm) |
| substrate | 1.806 | |
| first layer | 1.46 | 38.2 |
| second layer | 2.11 | 14.0 |
| third layer | 1.30 | 117.3 |

FIG. 10 illustrates a characteristic of the optical element according to the comparative example 1 measured by the spectroreflectometer, in which the abscissa axis denotes a wavelength (nm), and the ordinate axis denotes reflectance (%). As illustrated in FIG. 10, when the optical element according to the comparative example 1 is compared with that of the first embodiment, the reflectance is higher and antireflection performance deteriorates in the visible range of wavelength of 400 nm to 700 nm at the incident angle of 0°. In the observation of surface film strength under the same conditions as the first embodiment, scratches are observed.

### COMPARATIVE EXAMPLE 2

An optical element according to a comparative example 2 also has the configuration illustrated in FIG. 1. The substrate 11 is made of a transparent glass substrate having a refractive index of 2.003 for the d-line. After the glass substrate is rinsed, the first layer 12 is formed using SiO₂ having a refractive index of 1.48 for the d-line to have a physical film thickness of only 29.0 nm through the vacuum evaporation method. Next, the second layer 13 is formed by using an evaporation material having a refractive index of 1.90 for the d-line to have a physical film thickness of only 23.7 nm through a vacuum evaporation method. Next, the third layer 102 is formed by coating an adjusted mixture solution of a solution containing hollow SiO₂ particles and a binder solution by using a spin coater to have a physical film thickness of 114.8 nm. The refractive index of the d-line is 1.30. The condition of rotation speed of the spin coater is preset. After the coating, the product is calcined in a clean oven in a temperature range of 100° C. to 250° C. for one hour. Table 10 describes the d-line refractive index and thickness of the optical element according to the comparative example 2.

TABLE 10

| | refractive index | physical film |
|---|---|---|
| | (λ = 587.6 nm) | thickness (nm) |
| substrate | 2.003 | |
| first layer | 1.48 | 29.0 |
| second layer | 1.90 | 23.7 |
| third layer | 1.30 | 114.8 |

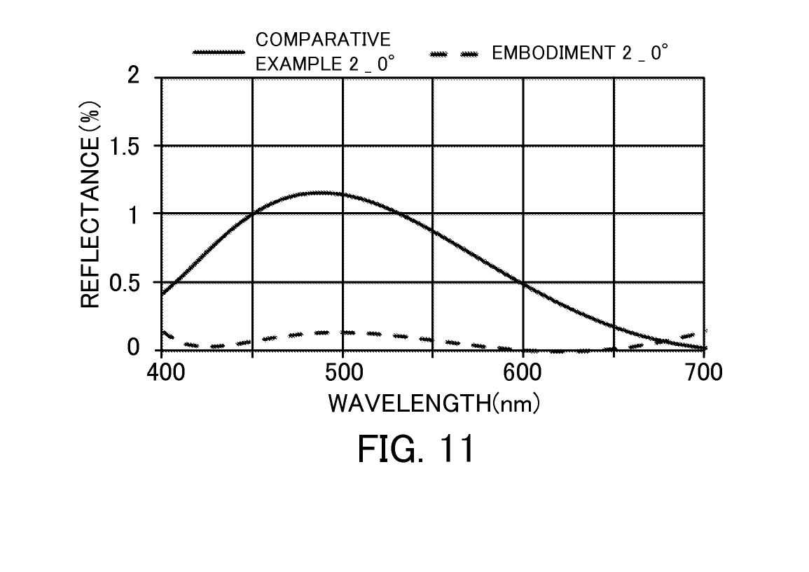

FIG. 11 illustrates a characteristic of the optical element according to the comparative example 2 measured by the spectroreflectometer, in which the abscissa axis denotes a wavelength (nm), and the ordinate axis denotes reflectance (%). As illustrated in FIG. 11, when the optical element according to the comparative example 2 is compared with the second embodiment, the reflectance is higher and antireflection performance deteriorates in the visible range of wavelength of 400 nm to 700 nm at the incident angle of 0°. In the observation of surface film strength under the same conditions as the second embodiment, scratches are observed.

The present invention can provide an optical element, an optical system, and an optical apparatus having an excellent low reflectance characteristic and having a high antireflection performance for a high reflective index glass.

The optical element is applicable to lenses or the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-248743, filed Nov. 12, 2012, which is hereby incorporated by reference herein in its entirety.

What is claimed is:

1. An optical element comprising:
a substrate that is transparent to light in a wavelength range to be used; and
an antireflective film laminated on the substrate,
wherein the antireflective film includes, in order from the substrate, a first layer, a second layer, and a third layer,
wherein the substrate has a refractive index of 1.80 to 2.05 for a d-line,
wherein the first layer is an inorganic oxide film having a refractive index of 1.43 to 1.47 for the d-line and a physical film thickness of 29.0 to 40.0 nm and containing silica as a main component,
wherein the second layer is an inorganic oxide film having a refractive index of 2.00 to 2.20 for the d-line and a physical film thickness of 12.0 to 41.0 nm, and
wherein the third layer is a film having a refractive index of 1.23 to 1.26 for the d-line and a physical film thickness of 110.0 to 130.0 nm and containing silica nanoparticles.

2. The optical element according to claim 1, wherein the silica nanoparticle is a hollow nanoparticles.

3. The optical element according to claim 2, wherein an average particle diameter of the hollow nanoparticle is 20 nm or more and 70 nm or less.

4. The optical element according to claim 3, wherein the second layer is made of zirconium oxide, titanium oxide, tantalum oxide, niobic oxide, hafnium oxide, lanthanum oxide, alumina, or silica, or a mixture of at least two thereof.

5. The optical element according to claim 1, wherein the silica nanoparticle is a mesoporous silica particle.

6. An optical system comprising an optical element, wherein the optical element includes a substrate that is transparent to light in a wavelength range to be used, and an antireflective film laminated on the substrate, wherein the antireflective film includes, in order from the substrate, a first layer, a second layer, and a third layer, wherein the substrate has a refractive index of 1.80 to 2.05 for a d-line, wherein the first layer is an inorganic oxide film having a refractive index of 1.43 to 1.47 for the d-line and a physical film thickness of 29.0 to 40.0 nm and containing silica as a main component, wherein the second layer is an inorganic oxide film having a refractive index of 2.00 to 2.20 for the d-line and a physical film thickness of 12.0 to 41.0 nm, and wherein the third layer is a film having a refractive index of 1.23 to 1.26 for the d-line and a physical film thickness of 110.0 to 130.0 nm and containing silica nanoparticles.

7. An optical apparatus comprising an optical element, wherein the optical element includes a substrate that is transparent to light in a wavelength range to be used, and an antireflective film laminated on the substrate, wherein the antireflective film includes, in order from the substrate, a first layer, a second layer, and a third layer, wherein the substrate has a refractive index of 1.80 to 2.05 for a d-line, wherein the first layer is an inorganic oxide film having a refractive index of 1.43 to 1.47 for the d-line and a physical film thickness of 29.0 to 40.0 nm and containing silica as a main component, wherein the second layer is an inorganic oxide film having a refractive index of 2.00 to 2.20 for the d-line and a physical film thickness of 12.0 to 41.0 nm, and wherein the third layer is a film having a refractive index of 1.23 to 1.26 for the d-line and a physical film thickness of 110.0 to 130.0 nm and containing silica nanoparticles.
